(19) United States
(12) Patent Application Publication
(10) Pub. No.: US 2023/0411621 A1
(43) Pub. Date: Dec. 21, 2023

(54) COMPOSITE CATHODE MATERIAL

(71) Applicant: Dyson Technology Limited, Wiltshire (GB)

(72) Inventors: Robert Ian Joseph GRUAR, Swindon (GB); Neil Ross SIM, Swindon (GB)

(73) Assignee: Dyson Technology Limited, Wiltshire (GB)

(21) Appl. No.: 18/035,581

(22) PCT Filed: Oct. 27, 2021
(86) PCT No.: PCT/GB2021/052793

§ 371 Date: May 5, 2023

(30) Foreign Application Priority Data
Nov. 26, 2020 (GB) 2018640.9

(51) Int. Cl. H01M 4/62; H01M 4/525; H01M 4/505; H01M 4/58; H01M 4/485; H01M 4/131; H01M 4/1391; H01M 4/136; H01M 4/1397; H01M 4/04; H01M 10/0585; H01M 10/0565; H01M 10/0562; H01M 50/434; H01M 50/414

(52) U.S. Cl. CPC H01M 4/62; H01M 4/525; H01M 4/505; H01M 4/5825; H01M 4/485; H01M 4/131; H01M 4/1391; H01M 4/136; H01M 4/1397; H01M 4/0485; H01M 4/0433; H01M 4/0404; H01M 10/0585; H01M 10/0565; H01M 10/0562; H01M 50/434; H01M 50/414; H01M 2004/028

(57) ABSTRACT

A composite cathode material includes a gel polymer electrolyte and particles of a cathode material. The particles of the cathode material are arranged in the gel polymer electrolyte.

### TECHNICAL FIELD

The present invention relates to composite cathode materials, methods of manufacturing composite cathode materials, electrochemical cells, methods of manufacturing electrochemical cells, battery stacks comprising a plurality of laminate electrochemical cells, and electronic devices comprising electrochemical cells.

### BACKGROUND

Electrochemical cells typically comprise liquid electrolyte. Examples of electrochemical cells comprising liquid electrolyte include lithium-ion batteries. There are safety concerns regarding lithium-ion batteries because they are prone to thermal runaway. Given that the liquid electrolyte contained in the lithium-ion is flammable, there is a risk that such lithium-ion batteries may explode. Electrochemical cells comprising liquid electrolyte may also be prone to leakage. Moreover, while lithium-ion batteries are considered to be relatively efficient, there is a consumer demand for electrochemical cells having higher energy density.

Solid-state electrochemical cells have been developed which do not include liquid electrolyte. Higher energy densities can be achieved with some solid-state cells than with typical liquid-electrolyte-containing electrochemical cells. However, high material costs are associated with solid-state cells, and the process of manufacturing them is typically time consuming and expensive. Further, given that the layers of solid-state electrochemical cells typically have low deformability (e.g. a solid cathode layer and a solid separator layer abutting the solid cathode layer), reduced interfacial contact between the layers introduces inefficiencies such as reduced Li-ion transport. For these reasons (among others), there has been limited mainstream adoption of solid-state electrochemical cell technology.

### SUMMARY

In examples of a first aspect of the present disclosure, there is provided a composite cathode material comprising a gel polymer electrolyte and particles of a cathode material arranged in the gel polymer electrolyte. Such a composite cathode material is employed as a cathode layer in laminate electrochemical cells according to examples.

The inventors have identified that a cathode comprising composite cathode material as described herein typically provides improved interfacial contact between the cathode and the abutting layer(s) of the electrochemical cell due to the increased deformability of the cathode compared with solid state cathodes. Improved interfacial contact typically reduces inefficiencies in an electrochemical cell, e.g. allows for improved ion transport.

Further, in examples, providing the composite cathode material as a cathode layer in a laminate electrochemical cell obviates the need for a separate electrolyte layer. Accordingly, these electrochemical cells may be simpler and more cost-effective to manufacture than cells comprising separate cathode and electrolyte layers, while still providing satisfactory performance.

The gel polymer electrolyte (GPE) of the composite cathode material may be referred to as a solvent swollen polymer electrolyte, and comprises a polymeric membrane containing a salt/solvent combination: the gel polymer electrolyte comprises lithium salt, polymer, and solvent. The solvent acts as a plasticizer, so may also be referred to as a plasticizer. The gel polymer electrolyte acts as a matrix which holds the particles of cathode material.

In examples, the polymer comprises polyethylene oxide (PEO), polypropylene oxide (PPO), polymethylmethacrylate (PMMA) polyacrylonitrile (PAN), and/or polyvinylidene difluoride (PVDF). In examples, the polymer matrix comprises a blend of said polymers. In examples, the polymer matrix comprises one or more copolymers obtainable from said polymers (such as a PAN/PMMA copolymer). The polymer matrix is crosslinked.

The lithium salt comprises any suitable salt. For example, the lithium salt may comprise LiClO₄, LiBF₄, LIPF₆, LiAsF₆, LiCF₃SO₃, LiN(CF₃SO₂)₂ (LiTFSI), or combinations thereof. In examples, the lithium salt comprises LiO₄Cl, LiTFSI, or combinations thereof.

The solvent may be any suitable solvent. In examples, the solvent comprises polyethylene glycol (PEG), polyethylene glycol dimethyl ether (PEGDME), dibutyl phthalate (DBP), dimethyl phthalate (DMP), dioctyl phthalate (DOP), succinonitrile (SN), ethylene carbonate (EC), propylene carbonate (PC), diethyl carbonate (DEC), dimethyl carbonate (DMC), γ-butyrolactone (γ-BL), or combinations thereof.

In examples, the gel polymer electrolyte layer comprises inorganic fillers. A gel polymer electrolyte layer comprising inorganic fillers typically exhibits improved mechanical properties.

The fluid nature of the gel polymer electrolyte as part of the composite cathode material means that it may act as a planarizing layer during manufacture of a laminate electrochemical cell.

In examples, the gel polymer electrolyte is obtainable from a UV-crosslinkable gel polymer electrolyte precursor. Such a gel polymer electrolyte may be referred to as a UV-crosslinked gel polymer electrolyte. Employing UV-crosslinked gel polymer electrolyte advantageously allows the composite cathode material to be formed into rolled sheets of composite cathode material to be used in a roll-to-roll manufacture of electrochemical cells, thereby reducing the cost and time involved in manufacturing an electrochemical cell. Methods of providing such a UV-crosslinked gel polymer electrolyte are discussed hereinbelow.

The particles of cathode material are dispersed throughout the gel polymer electrolyte. The particles of cathode material are for example arranged in the gel polymer electrolyte such that each of the particles of cathode material at least partially contacts the gel polymer electrolyte. In examples, the concentration of particles of cathode material are substantially constant in a first plane of the composite material along a second plane of the composite material (e.g. the concentration of particles across the thickness of the composite material is substantially constant along the width or length of the composite material).

In examples, the particles of cathode material are substantially homogeneously dispersed through the gel polymer electrolyte of the composite cathode material e.g. portions throughout the composite cathode material in a first, second, and third dimension comprise similar concentrations of cathode material particles, within acceptable tolerances (allowing for small fluctuations which do not materially impact the performance of the composite cathode material). The composite cathode material typically does not comprise sublayers comprising significantly higher or lower concentrations of cathode material. Such substantial homogeneity is achieved, for example, by mixing gel polymer electrolyte precursor with particles of cathode material, and casting and cross-linking the mixture before the particles of cathode material settle in the mixture to provide sublayers comprising significantly higher or lower concentrations of cathode material. In examples, the composite cathode material does not comprise significant agglomerates of cathode material (e.g. agglomerates having a size which materially impacts the performance of the composite cathode material).

Dispersing the particles of cathode material substantially homogenously throughout the gel polymer electrolyte typically provides for greater surface area contact between the cathode material and the gel polymer electrolyte.

The particles of cathode material typically constitute on a dry weight basis at least 50 wt % of the composite cathode material. In examples, the particles of cathode material constitute on a dry weight basis at least 60 wt %, 70 wt %, 80 wt %, or 85 wt % of the composite cathode material. A composite cathode material having a high cathode material content typically allows for an electrochemical cell having a high energy density.

The cathode material provided in particulate form in the composite cathode material is material which is suitable for use as a cathode in an electrochemical cell. In examples, the cathode material is a material typically employed in cathodes of solid-state batteries. The cathode material provided in particulate form in the composite cathode material typically comprises material comprising one or more lithium species such as lithium-based oxides or lithium-based phosphates. In examples, the cathode material comprises: lithium cobalt oxide (LiCoO₂), typically referred to as LCO; lithium manganese oxide (LiMn₂O₄), typically referred to as LMO; lithium nickel manganese cobalt oxide (LiNi_{1-x-y}MnₓCoyO₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA; lithium sulfide (Li₂S); silver vanadium oxide (AgV₂O_{5.5}), typically referred to as SVO; and combinations thereof (e.g. the cathode material may comprise a composite of any of the materials described herein). In examples, the cathode material is crystalline (e.g. the particles of cathode material have a crystalline structure).

The particles of cathode material are provided in any suitable form, e.g. shards, strands, granules. Typically, the particles of cathode material are granular, and may be provided as a powder. In examples, the particles of cathode material provides a high contact surface area with the gel polymer electrolyte in which it is provided.

In examples, the particles of the cathode material have a relatively small particle size. As used herein, particle size refers to the greatest cross-sectional extent of the particle. Typically, a small particle size allows for a greater surface area to volume ratio of the cathode material, such that across the composite cathode material there is a greater contact surface area between the gel polymer electrolyte and the particles of cathode material.

The particles of the cathode material in examples have an average particle size of less than 0.1 μm. As used herein, average particle size refers to the mean average of particle sizes across the particles provided in the composite cathode material.

In examples, the composite cathode material is porous. When provided as a cathode layer of an electrochemical cell, a porous composite cathode material may allow deformable electrolyte material (separate from the composite cathode material itself) to extend through the cathode layer, thus increasing conductivity in the cell. In particular, electrolyte material extending through the cathode layer may enhance the Li-ion transport number.

The composite cathode material is provided in examples as a sheet, e.g. having a greater extent in a first (length) and second (width) dimension than a third dimension (thickness). In some examples the sheet is provided alone, substantially without other materials provided on any of the faces of the sheet. In other examples, the sheet is provided on a support layer, e.g. affixed to a support layer. The sheet may be provided as a wound roll or bobbin.

In examples of a second aspect of the present disclosure, there is provided a method of manufacturing a composite cathode material. The method comprises mixing particles of a cathode material with a gel polymer electrolyte precursor to provide a mixture; and cross-linking the gel polymer electrolyte precursor of the mixture to provide the composite cathode material.

The particles of cathode material are any of those described hereinabove and is the dispersed phase (e.g. solid phase) in the mixture. The gel polymer electrolyte precursor is typically fluid, e.g. liquid, and is the dispersion phase (e.g. continuous phase) in the mixture.

The mixing the particles of cathode material with the gel polymer electrolyte precursor comprises any suitable mixing technique for suspending the particles of cathode material in the continuous phase. For example, the mixing may comprise supplying the particles of cathode material and the gel polymer electrolyte precursor to a mixer, and operating the mixer. The mixer in examples is a tank provided with a disperser (e.g. a rotor-stator mixer).

In examples, the gel polymer electrolyte precursor is first charged to the mixer, and then the particles of cathode material added.

In examples the mixture is a slurry comprising the particles of cathode material and gel polymer electrolyte precursor. The mixture is typically a colloidal suspension of the particles in the precursor.

A gel polymer electrolyte precursor is a material which is capable of crosslinking (e.g. curable) to provide a gel polymer electrolyte as described hereinabove. Typically, the gel polymer electrolyte precursor comprises lithium salt, polymer, and solvent. The gel polymer electrolyte precursor in some examples comprises further components such as filler.

Not all of the components of the gel polymer electrolyte precursor need to be capable of crosslinking for the precursor to be considered capable of crosslinking (crosslinkable). For example, a gel polymer electrolyte precursor which comprises crosslinkable polymer is a crosslinkable gel polymer electrolyte precursor.

Before cross-linking the gel polymer electrolyte precursor, the mixture is, for example, cast to form a sheet of mixture. In these examples, crosslinking the gel polymer electrolyte precursor will provide a sheet of cathode composite material.

In particular examples, before crosslinking, the mixture is supplied to a surface of a current collector (discussed hereinbelow) to provide a current collector-mixture laminate. A current collector is typically a metal foil (e.g. copper, nickel, stainless steel), metal screen, metal film on a polymer film or sufficiently conductive SiO₂ layer, or any other known substrate or barrier layer. Current collectors typically have a thickness suitable for providing structural support to the layers of the electrochemical cell arranged therebetween. In some examples, e.g. where the current collector is configured to form an electrode on both faces of the layer, the current collector comprises a polymer layer having a first surface and an opposing second surface, a metal layer on the first surface, and a metal layer on the second surface. Surprisingly, the inventors have identified that current collectors according to these examples can be manufactured to be thinner than, for example, current collectors consisting only of metal foil, while providing acceptable performance (e.g. conductivity and/or structural support). The current collectors according to these examples are particularly suitable for use in cells which are provided in a “back-to-back” battery stack, as the reduced thickness of the current collector results in a reduced stack height. In examples, the metal layers arranged on the first and second surfaces of the polymer layer are copper foil layers.

The mixture is supplied to the surface of the current collector according to any suitable method. In examples, the mixture is deposited on the surface via e.g. vacuum depositing and/or casting. In particular examples, the supplying the mixture of precursor to the surface of the first current collector comprises casting the mixture onto the surface. Examples of casting include spray casting, tape-casting, sheet casting, and spin casting. In other examples, the supplying the mixture comprises dip coating the first current collector with the mixture, e.g. at least partially immersing the first current collector in the mixture. In some of these examples, the first current collector is coated on a first surface and an opposing second surface of the current collector.

Crosslinking the precursor of the mixture in these examples provides a composite cathode material which is affixed to the surface of the current collector. The composite cathode material and current collector may together be referred to as a current collector-composite cathode laminate.

In other examples, the mixture is supplied to a mold before cross-linking the gel polymer electrolyte precursor. In these examples, crosslinking the gel polymer electrolyte precursor will provide a cathode composite material having a shape which is the negative impression of the mold.

In some examples, the crosslinking comprises leaving the mixture for a duration to allow crosslinking to occur. In other examples, the crosslinking comprises inducing the precursor to crosslink. For example, the crosslinking comprises supplying heat, pressure, or irradiation (e.g. ultraviolet (UV) radiation or infrared (IR) radiation) to the precursor, and/or supplying an initiator to the precursor. In particular examples, the crosslinking comprises supplying UV radiation to the gel polymer electrolyte precursor (e.g. exposing the gel polymer electrolyte precursor to UV radiation). The inventors have identified that using a UV-curable gel polymer electrolyte precursor can be crosslinked in a quicker and cheaper fashion than other gel polymer electrolyte precursors.

Examples of the method include, after the cross-linking, winding the composite cathode material into a bobbin (e.g. a roll). In particular examples, the method comprises mixing particles of a cathode material with a gel polymer electrolyte precursor to provide a mixture, supplying the mixture to a surface of a current collector, and cross-linking the gel polymer electrolyte precursor of the mixture to provide the composite cathode material as part of a current collector-cathode laminate. Typically, the current collector-cathode laminate is formed into a roll (e.g. wound into a bobbin) for use in roll-to-roll manufacture of a laminate electrochemical cell.

According to a third aspect of the present disclosure, there is provided a laminate electrochemical cell. The laminate electrochemical cell comprises an anode layer, and a composite cathode layer comprising the composite cathode material described hereinabove.

The composite cathode layer typically has a first surface facing the anode layer and a second surface opposite the first surface, a current collector being disposed on the second surface of the composite cathode layer. Taken together, the current collector and composite cathode layer may be referred to as a current collector-composite cathode laminate, as described hereinabove. In examples, the current collector is configured to form an electrode on both faces of the layer, e.g. for use in a battery stack.

Typically, the composite cathode layer is the only layer present in the electrochemical cell which functions as a cathode in use. For example, the electrochemical cell does not comprise a solid cathode layer (e.g. cathode material which is not arranged in a gel polymer electrolyte matrix).

The anode comprises any material suitable for use in an anode of an electrochemical cell. In examples the anode comprises silicon, carbon, indium tin oxide (ITO), molybdenum dioxide (MoO₂), lithium titanate (Li₄Ti₅O₁₂—typically referred to as LTO), lithium alloy, metallic lithium, or combinations thereof. Where the anode comprises carbon, the anode comprises any suitable carbon-based material. For example, the anode comprises graphite, graphene, hard carbon, activated carbon, and/or carbon black.

In examples, the anode comprises a lithium-intercalation material. Any of the materials listed hereinabove may be provided as a lithium-intercalated material to the extent that it is technically achievable. For example, the anode comprises lithium-intercalated silicon, lithium-intercalated graphite, or lithium-intercalated graphene. In examples, the anode comprises intercalated silicon or lithium-intercalated graphite.

Typically, the anode layer has a first surface facing the composite cathode layer and a second surface opposite the first surface, a current collector being disposed on the second surface anode layer. As described hereinbelow, examples of manufacturing the electrochemical cell include depositing material on a current collector to provide an anode layer on the current collector.

The current collector is typically a metal foil (e.g. copper, nickel, stainless steel), metal screen, metal film on a polymer film or sufficiently conductive SiO₂ layer, or any other known substrate or barrier layer. In examples, the current collector is configured to form an electrode on both faces of the layer, e.g. for use in a battery stack.

The anode is typically coated on a current collector. For example, the anode may be a Li metal film anode coated on copper foil, or a graphite anode coated on copper foil.

In examples, the laminate electrochemical cell comprises at least one gel polymer electrolyte layer arranged between the anode layer and the composite cathode layer. In some examples, a gel polymer electrolyte layer abuts (is in direct contact with) the composite cathode layer; the gel polymer electrolyte layer coats at least a portion of the composite cathode layer. In examples, the gel polymer electrolyte layer coats at least 80%, 90%, or substantially all of the first surface of the composite cathode layer. Advantageously, the gel polymer electrolyte layer of these examples provides a flexible, conformal interface with the layer arranged along the face of the gel polymer electrolyte opposite the composite cathode layer, e.g. the anode layer.

In some examples, a gel polymer electrolyte layer abuts (is in direct contact with) the anode layer; the gel polymer electrolyte layer coats at least a portion of the anode layer. In examples, the gel polymer electrolyte layer coats at least 80%, 90%, or substantially all of the first surface of the anode layer.

In some examples, the gel polymer electrolyte layer abutting the composite cathode layer is the gel polymer electrolyte layer which abuts the anode layer; a single gel polymer electrolyte layer directly contacts both the composite cathode layer and the anode layer. In other examples, a first gel polymer electrolyte layer abuts the composite cathode layer, and a second gel polymer electrolyte layer abuts the anode layer (e.g. there is an intermediate layer at least partially separating the first and second gel polymer electrolyte layers). The first and second polymer electrolyte layers are, in examples, in fluid communication with each other, but are at least partially separated by an intermediate layer. The first and second gel polymer electrolyte layers typically have the same composition.

For the avoidance of doubt, the cathode comprising composite cathode material is distinct from the polymer electrolyte layer of the laminate electrochemical cell. While the gel polymer electrolyte layer and the composite cathode layer may have one or more components in common, the gel polymer electrolyte layer is essentially free of cathode material (e.g. the polymer electrolyte layer does not comprise cathode material in an amount for the polymer electrolyte layer to effectively function as a cathode). For example, the gel polymer electrolyte layer essentially consists of, or consists of, gel polymer electrolyte as described hereinabove.

The gel polymer electrolyte in examples comprises any of the gel polymer electrolytes described above in relation to the composite cathode material (in the absence of the particles of cathode material). The gel polymer electrolyte of these examples may at least partially function as a separator in the laminate electrochemical cell.

In examples, the laminate electrochemical cell comprises a ceramic layer arranged between the anode layer and the composite cathode layer.

The ceramic layer comprises ceramic electrolyte material. In examples, the ceramic layer is a crystalline lithium-ion (‘Li-ion’) ceramic. In examples, the ceramic layer is an amorphous/glass ceramic. The ceramic layer typically functions as a separator between the cathode and the anode, preventing the anode and cathode from coming into direct contact and thereby short-circuiting the cell.

The ceramic layer typically comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); related amorphous glassy type Li-ion conductors, or combinations thereof (e.g. the ceramic layer may comprise a composite of any of the materials described herein). In a particular embodiment, the ceramic layer comprises lithium phosphorous oxy-nitride (LiPON), the LiPON having the following formula: LiₓPO_{y}N_{z} where x=2y+3z−5, and x<4. In examples, the ceramic layer comprises at least 50 wt %, 80 wt %, 90 wt %, 95 wt % or 99 wt % LiPON by dry weight of the ceramic layer. In examples where the ceramic layer comprises LiPON, the ceramic layer is typically referred to as ‘the LiPON layer’.

The ceramic layer is arranged between the composite cathode layer and the anode layer. In examples, the ceramic layer abuts (is in contact with) the anode layer. In examples, the ceramic layer coats at least 80%, 90%, or substantially all of the first surface of the anode layer. In examples, the ceramic layer is a LiPON layer and coats at least 80%, 90%, or substantially all of the first surface of the anode layer. The inventors have identified that arranging the layers in this manner allows for separation of the cathode and anode whilst having a small layer thickness, allowing for a slimmer electrochemical cell.

In some examples, the ceramic layer abuts both the composite cathode layer and the anode layer; the laminate electrochemical cell does not comprise a gel polymer electrolyte layer. As described hereinabove, this simplified cell structure, at least partially provided for by the nature of the composite cathode layer, is typically simpler and more cost-effective to produce, while maintaining satisfactory performance.

The laminate electrochemical cell in some examples comprises a composite cathode layer, a gel polymer electrolyte layer, a ceramic layer, and an anode layer, the gel polymer electrolyte layer and the ceramic layer arranged between the cathode layer and the anode layer. For example, the gel polymer electrolyte layer abuts the composite cathode layer, the ceramic layer abuts the gel polymer electrolyte layer, and the anode layer abuts the ceramic layer.

In some examples, the ceramic layer abuts neither the anode nor the cathode. In these examples, the ceramic layer is typically arranged between the first and second gel polymer electrolyte layers described hereinabove. This structure provides effective separation of the composite cathode layer and the anode layer whilst providing good interfacial contact between the layers due to the flexibility of the gel polymer electrolyte layers therebetween. By providing a gel polymer electrolyte layer between the ceramic layer and the anode/composite cathode in these examples, the ceramic layer is less prone to degradation, meaning that more reactive anode materials can be employed.

Where the electrochemical cell comprises a ceramic layer, typically only one ceramic layer is present in the cell. The present inventors have identified that, surprisingly, an electrochemical cell comprising only one ceramic layer disposed on the anode, or arranged between layers of gel polymer electrolyte, provides performance which is comparable with an electrochemical cell comprising a first ceramic layer coating the cathode and a second ceramic layer coating the anode (referred to herein as a “double coated cell”). Accordingly, the electrochemical cell described herein may be simpler and more cost-effective to manufacture than a double coated cell while still providing satisfactory performance.

In some examples, the ceramic layer is porous. For example, the ceramic layer has a series of pores extending through the entire thickness of the ceramic layer. In these examples, the ceramic layer may be referred to as a ceramic mesh. The ceramic layer being porous may allow deformable electrolyte material to extend through the ceramic layer (e.g. material of the gel polymer electrolyte layer). Electrolyte material extending through the ceramic layer thus may increase conductivity in the cell. In particular, electrolyte material extending through the ceramic layer may enhance the Li-ion transport number (also referred to as the transference number). Further, the inventors have identified that, in examples, filling pores of the brittle ceramic layer with polymer electrolyte improves the stability of the ceramic layer, whilst also allowing for expansion and contraction of the polymer electrolyte. Moreover, a porous ceramic layer may have a lower mass than a corresponding non-porous ceramic layer, thereby reducing the mass of the cell and thus increasing the energy density of the cell.

As described hereinabove, in some examples the ceramic layer abuts neither the anode nor the cathode, and is arranged between first and second gel polymer electrolyte layers. Where the ceramic layer is porous and arranged thus, the first gel polymer electrolyte layer contacts the second gel polymer electrolyte layer through the pores of the porous ceramic layer.

In other examples, the ceramic layer is not porous. In examples, the ceramic layer does not comprise polymer (e.g. is distinct from the polymer electrolyte layers; the layers are discrete).

In examples, the ceramic layer comprises a homogenous material. The homogenous material comprises ceramic, and does not comprise polymer electrolyte. Although in some examples the polymer electrolyte of the polymer electrolyte layer may extend through portions of the ceramic layer (e.g. where the ceramic layer is porous and the polymer electrolyte layer comprises gel polymer electrolyte), in these examples, because the homogenous material comprised in the ceramic layer does not itself comprise polymer electrolyte, the ceramic layer is said to not comprise polymer electrolyte.

Each of the cathode, ceramic, polymer electrolyte, and anode are provided as layers. A layer may also be referred to as a sheet. A layer extends in a first dimension (length), a second dimension perpendicular to the first dimension (width), and a third dimension perpendicular to both the first and second dimensions (thickness). The thickness is typically the smallest dimension of a layer of an electrochemical cell described herein. Each layer of the electrochemical cell has a thickness. For example, FIG. 1 depicts the cathode 11 having a thickness 11c.

In examples, at least one of the layers present in the electrochemical cell has a thickness greater than or equal to 10 nm, 100 nm, or 1 μm. In examples, at least one of the layers present in the electrochemical cell has a thickness less than or equal to 10 μm. In particular examples, the ceramic layer and polymer electrolyte layer taken together have an aggregate thickness greater than or equal to 1 μm, or 10 μm. Without wishing to be bound by theory, it is believed that the combination of a ceramic layer and polymer electrolyte layer having a given aggregate thickness has a higher conductivity than the electrolyte of a conventional solid-state cell having the same thickness. Thus, the electrochemical cells described herein may comprise one or more layers having a greater thickness than corresponding solid-state cells while maintaining high performance. The ceramic layer and polymer electrolyte layer together having a greater aggregate thickness may allow for a cell having thicker cathode layer(s).

In examples, at least two, three or four of the layers has a thickness greater than or equal to 10 nm, 100 nm, or 1 μm. In examples, each layer has a thickness greater than or equal to 0.2 μm.

Examples of the electrochemical cells described herein include primary cells (e.g. disposable cells) and secondary cells (e.g. rechargeable cells).

In examples of a fourth aspect of the present disclosure, there is provided a method of manufacturing a laminate electrochemical cell. The method comprises providing a layer of composite cathode material as described hereinabove, providing an anode layer, and combining the layer of composite cathode material and the anode layer to provide the laminate electrochemical cell. Said method typically provides an electrochemical cell as described hereinabove.

The providing the layer of composite cathode material typically comprises any of the methods described hereinabove in relation to the second aspect of the disclosure. For example, the providing the layer of composite cathode material comprises supplying (e.g. depositing) a mixture of gel polymer electrolyte precursor and particles of a cathode material to a surface of a first current collector, and cross-linking the gel polymer electrolyte precursor of the mixture to provide the layer of composite cathode material. In these examples, the composite cathode layer is typically affixed to the first current collector.

The depositing the mixture to the surface of the first current collector comprises any suitable method for supplying the mixture to the surface. In examples, the depositing comprises vacuum depositing, and/or casting. In particular examples, the supplying the mixture of precursor to the surface of the first current collector comprises casting the mixture onto the surface. Examples of casting include spray casting, sheet casting, and spin casting.

The providing the anode layer in examples comprises depositing anode-layer material on a surface of a second current collector. The depositing is carried out according to any deposition method suitable for depositing the relevant material on a substrate. In examples, the depositing comprises vacuum depositing, electroplating, electrophoretic depositing, and/or casting.

In examples, the depositing comprises physical vapour depositing. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour depositing. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting.

The current collector on which the anode-layer material is deposited is separate from the current collector to which the composite cathode material abuts in examples. An anode-layer material is any material which functions as an anode, or a material which can be treated to provide a material which functions as an anode. An anode-layer material which is treated to provide a material which functions as an anode is also referred to as an anode precursor.

In examples, the anode-layer material comprises any of the materials described hereinabove in relation to the anode layer, or precursors to said materials. Suitably, the anode-layer material is one which undergoes a formation charge to plate lithium to the anode-layer material.

In examples, the anode-layer material is lithium metal, and the depositing the lithium metal on the second current collector provides a lithium metal film. Typically, lithium metal is deposited on the second current collector via thermal deposition.

The lithium metal sheet may undergo a cooling process after its thermal deposition on the current collector. For example, the lithium metal film undergoes laser ablation. In other examples, the lithium metal sheet does not undergo a cooling process. For example, the lithium metal film does not undergo laser ablation. The present inventors have identified that the laser ablation process is optional in this example because it is not necessary to cool the lithium metal sheet layer before continuing with the method. Obviating the need for this process simplifies the manufacturing method such that the method may be quicker, simpler, and more cost-efficient.

The combining the composite cathode layer and anode layer typically comprises aligning and lamination of the composite cathode layer and the anode layer (with any other intermediate layers disposed therebetween) to provide the electrochemical cell. Such alignment and lamination is achieved by any suitable method. For example, the combining may comprise hot rolling and/or hot pressing.

In examples, the method further comprises providing a gel polymer electrolyte layer on a surface of the layer of composite cathode material. The gel polymer electrolyte layer is provided on the surface of the composite cathode layer according to any suitable process

In some examples, supplying the gel polymer electrolyte comprises casting a mixture comprising polymer, lithium salt and solvent on the composite cathode layer, and crosslinking the mixture, thereby providing the gel polymer electrolyte layer.

The polymer is typically selected to have a suitable dielectric constant. In examples, the polymer has a dielectric constant (Cr) less than or equal to 10, or less than or equal to 6. In some examples, the polymer has a dielectric constant of approximately 1. Suitable polymers comprise PPO, PEO, MAN/PMMA and/or PVDF, for example; suitable lithium salts comprise LiO₄Cl, LiTFSI, and/or LiPF₆, for example. The mixture typically undergoes crosslinking to form a polymer electrolyte matrix, initiated upon application of heat, UV radiation and/or IR radiation, for example. The mixture cast on the composite cathode layer typically forms a layer having a thickness of approximately 10 μm.

In other examples, providing the gel polymer electrolyte layer comprises depositing a polymer film on the composite cathode layer. Depositing the polymer film comprises vacuum deposition and/or electrophoretic deposition of polymer, for example. Again, the polymer is typically selected to have a suitable dielectric constant (K). In examples, the polymer has a dielectric constant less than or equal to 10, or less than or equal to 6. In some examples, the polymer has a dielectric constant of approximately 1. Suitable polymer films comprise PPO, PEO, MAN/PMMA and/or PVDF, for example. The polymer film typically has a thickness of less than 10 micrometres (μm).

In these examples the depositing also comprises supplying a lithium salt solution to the polymer film. In examples, the lithium salt comprises LiO₄Cl, LiTFSI, and/or LiPF₆. The lithium salt is provided in a solvent, typically an organic solvent. The solvent is any suitable solvent, and is typically selected so that it sufficiently wets the polymer film (e.g. forms a contact angle θ with the polymer film of 0<θ<90°).

The material deposited to form the polymer electrolyte layer is then crosslinked. In examples, said crosslinking is initiated upon application of heat, ultraviolet (UV) radiation, and/or infrared (IR) radiation.

Taken together, the gel polymer electrolyte layer on the composite cathode layer is referred to as a gel polymer electrolyte-composite cathode laminate. The combining the layer of composite cathode material and the anode layer comprises arranging the gel polymer electrolyte layer between the layer of composite cathode material and the anode layer. The arranging the gel polymer electrolyte layer typically comprises combining the gel polymer electrolyte-composite cathode laminate with the anode layer such that the gel polymer electrolyte layer is arranged between the anode layer and the cathode layer.

In examples, the method further comprises providing a ceramic layer on a surface of the anode layer. The providing the ceramic layer comprises any method suitable for providing the ceramic layer on the surface of the anode layer, e.g. depositing the ceramic layer on the surface. The ceramic is deposited according to any of the methods described hereinabove. In examples, the ceramic is deposited via vacuum deposition such as PVD or CVD.

Taken together, the ceramic layer on the surface of the anode layer is referred to as a ceramic-anode laminate. The combining the layer of composite cathode material and the anode layer in these examples comprises arranging the ceramic layer between the layer of composite cathode material and the anode layer. The arranging the ceramic layer typically comprises combining the ceramic-anode laminate and the composite cathode layer such that the ceramic layer is arranged between the anode layer and the cathode layer.

In particular examples, the method comprises both providing a gel polymer electrolyte layer on a surface of the composite cathode layer, and a ceramic layer on a surface of the anode layer. In these examples, the combining comprises combining the ceramic-anode laminate with the gel polymer electrolyte-composite cathode laminate such that the gel polymer electrolyte layer abuts the ceramic layer. Said combining is typically aligning and lamination (e.g. hot rolling and/or hot pressing) of the ceramic-anode laminate and the gel polymer electrolyte-composite cathode laminate in a roll-to-roll process.

In examples, once the composite cathode layer, anode layer, and any further layers disposed therebetween have been combined to provide the laminate electrochemical cell, the method further comprises winding the laminate electrochemical cell to provide a wound laminate electrochemical cell. For example, the laminate electrochemical cell is round wound to provide a wound laminate electrochemical cell suitable for a cylindrical cell case, or the laminate electrochemical cell is flat wound to provide a wound laminate electrochemical cell suitable for a prismatic cell case.

According to examples of a further aspect of the present disclosure there is provided a battery stack comprising a plurality of laminate electrochemical cells, each cell comprising a first current collector, a composite cathode layer as described hereinabove arranged on a surface of the first current collector, a second current collector, and n anode layer arranged on a surface of the second current collector. In examples, each laminate electrochemical cell is an electrochemical cell according to examples described hereinabove.

The plurality of cells may suitably comprise 2, 3, 4, 5, or more than 5 electrochemical cells. Said battery stack typically comprises a plurality of electrochemical cells as described herein.

In examples, the battery stack is a “back-to-back” stack. For example, the cathodes of two cells are arranged to contact a single current collector. Accordingly, in examples wherein the plurality of electrochemical cells comprises a first electrochemical cell and a second electrochemical cell, the first current collector of the first cell is also the first current collector of the second cell.

In examples, the anode of each cell comprises material typically used in conventional lithium-ion batteries. For example, the anode of each cell comprises silicon, carbon (optionally as graphite, graphene, activated carbon and/or carbon black), indium tin oxide (ITO), molybdenum dioxide (MoO₂), lithium titanate (Li₂TiO₃), lithium alloy, metallic lithium, copper, or combinations thereof. Said materials may suitably be lithium-intercalated, to the extent that it is technically achievable. Where the battery stack is a “back-to-back” stack, the anodes and second current collectors of the first and second electrochemical cells represent a conventional electrode.

Methods of manufacturing said battery stacks also form part of the present disclosure. Said methods typically correspond to those described herein in relation to manufacture of a cell, wherein the process is repeated to build a plurality of laminate cells arranged in a laminate stack structure.

In examples, the method comprises manufacturing a laminate structure comprising a composite cathode layer on a current collector, an anode on a current collector, and any further layers arranged therebetween, separating the structures into individual cells and folding the laminate structure in a ‘concertina’ or zig-zag fashion, thereby providing a battery stack of cells in which every other cell in the stack is reversed so that each current collector has either an anode on each opposing face or a composite cathode on each opposing face. In examples, the battery stack of cells is provided in a pouch cell, e.g. a stacked pouch cell.

In examples of a yet further aspect of the present disclosure there is provided an electrically-powered device comprising the electrochemical cell described herein, or the battery stack described herein. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, an RC car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device.

Features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a cross-section of a composite cathode material according to examples.

FIG. 2 is a schematic diagram of a cross-section of a battery stack according to examples.

FIG. 3 is a flow chart of a method according to examples.

FIG. 4 is a schematic flow diagram of a method according to examples, depicting cross-sections of an electrochemical cell and component portions of the electrochemical cell at points in the method.

FIG. 5 is a schematic flow diagram of a method according to examples, depicting cross-sections of an electrochemical cell and component portions of the electrochemical cell at points in the method.

FIG. 6 is a schematic flow diagram of a method according to an example, depicting cross-sections of an electrochemical cell and component portions of the electrochemical cell at points in the method.

### DETAILED DESCRIPTION

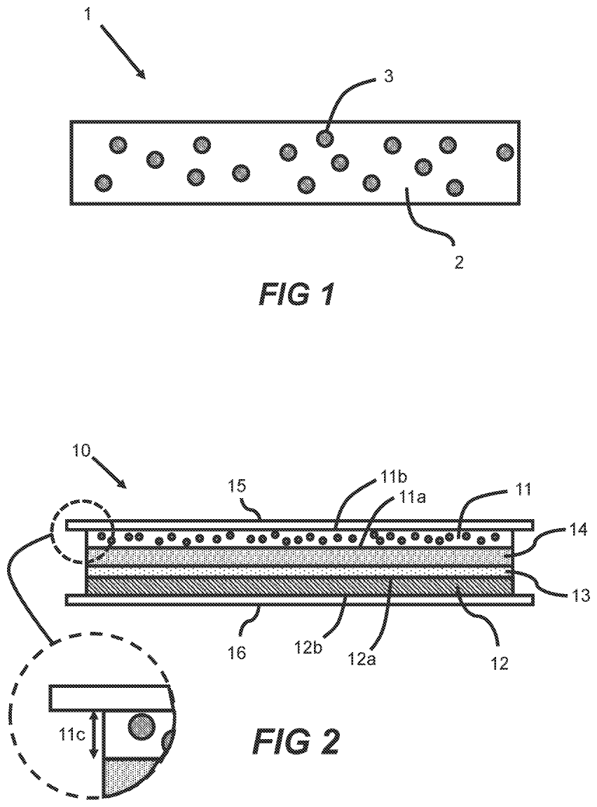

FIG. 1 shows a cross-section of one example of a composite cathode material 1 according to examples. The composite cathode material 1 comprises a gel polymer electrolyte 2 and particles of a cathode material 3 arranged in the gel polymer electrolyte 2. The particles of cathode material 3 are dispersed throughout the gel polymer electrolyte 2. The particles 3 are granular in form; the composite cathode material 1 is obtained from mixing gel polymer electrolyte precursor and powdered cathode material, and crosslinking the precursor to provide the composite cathode material 1.

FIG. 2 shows a cross-section of one example of an electrochemical cell 10 according to examples. The cell 10 comprises a composite cathode layer 11, an anode 12, a ceramic layer 13, and a gel polymer electrolyte layer 14. The cell 10 typically comprises current collectors 15, 16.

The ceramic layer 13 juxtaposes the anode 12 as a LiPON coating. The ceramic layer 13 contacts a first surface 12a of the anode layer.

The gel polymer electrolyte layer 14 juxtaposes the ceramic layer 13. The polymer electrolyte layer 14 and the ceramic layer 13 are different, discrete layers having different compositions.

The composite cathode layer 11 juxtaposes the gel polymer electrolyte layer 14. The gel polymer electrolyte layer contacts a first surface 11a of the composite cathode layer 11.

The composite cathode layer 11 of the cell 10 comprises the composite cathode material 1 depicted in FIG. 1. The anode layer 12 of the cell 10 comprises materials typically employed in conventional Li-ion electrochemical cells.

The first current collector 15 is arranged on a second surface 11b of the composite cathode 11, the second surface 11b being opposite to the interface between the composite cathode 11 and the gel polymer electrolyte layer 14 at the first surface 11a of the composite cathode 11. The second current collector 16 is arranged on a second surface 12b of the anode 12, the second surface 12b being opposite to the interface between the anode 12 and the ceramic layer 13 at the first surface 12a of the anode 12. The current collectors 15, 16 comprise a metal layer.

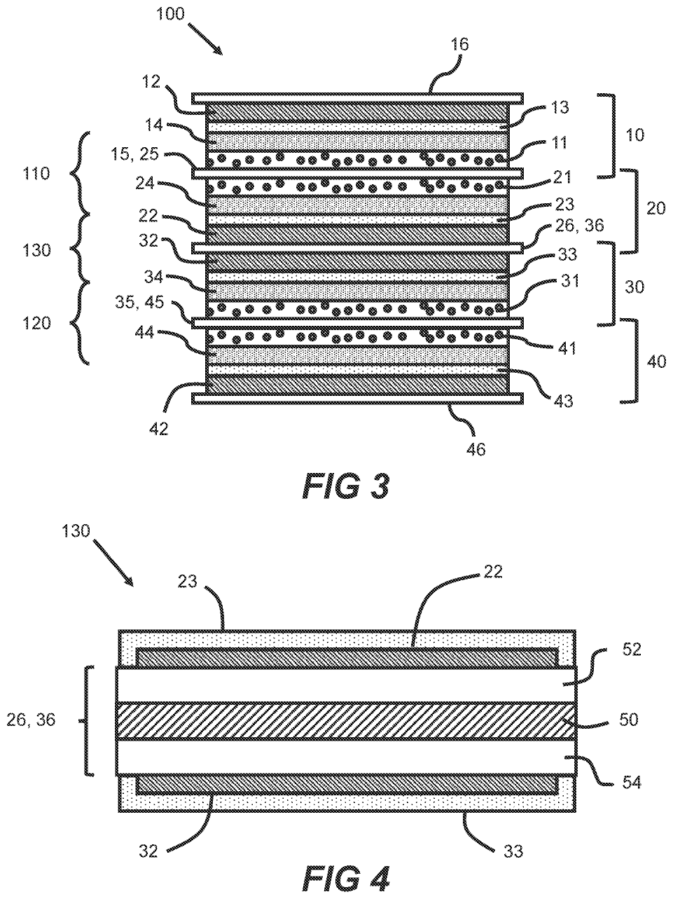

FIG. 3 shows a cross-section of one example of a battery stack 100 comprising a plurality of electrochemical cells 10, 20, 30, 40. As shown in FIG. 3, the plurality comprises a first cell 10, a second cell 20, a third cell 30, and a fourth cell 40. Other examples of battery stack 100 need only in fact comprise at least two electrochemical cells; and, the number of cells shown in FIG. 3 is purely exemplary. The description and teaching regarding FIG. 3 is also explicitly disclosed in relation to any battery stack comprising any number of electrochemical cells according to the present disclosure, to the extent that said teaching and said battery stack are technically compatible.

Each cell 10, 20, 30, 40 corresponds to the cell 10 shown in FIG. 2. The components of each cell 10, 20, 30, 40 are labelled such that the second digit corresponds to that used in FIG. 2 to indicate where components are equivalent, and the first digit corresponds to the first digit of the cell of which it is comprised.

The battery stack 100 is a “back-to-back” stack, in which every other cell in the stack is reversed so that each current collector has either an anode on each opposing face or a cathode on each opposing face. In particular, in FIG. 3, the composite cathode 11 of the first cell 10 and the composite cathode 21 of the second cell 20 are arranged on opposite faces of a current collector 15/25. The current collector 15/25 comprises an outer metal foil surface and a core having lower electrical conductivity than the outer metal foil surface, and thus is configured to form an electrode on both faces of the layer, e.g. the first current collector 15 of the first cell 10 and the first current collector 25 of the second cell 20. Thus, the first current collector 15 of the first cell 10 is the first current collector 25 of the second cell. The same applies to the first current collector 35 of the third cell 30 and the first current collector 45 of the fourth cell 40 mutatis mutandis.

The anode 22 of the second cell 20 and the anode 32 of the third cell 30 are arranged on opposite faces of a current collector 26/36. The current collector 26/36 comprises an outer metal foil surface and a core having lower electrical conductivity than the outer metal foil surface, and thus is configured to form an electrode on both faces of the layer, e.g. the second current collector 26 of the second cell 20 and the second current collector 36 of the third cell 30. Although not shown in FIG. 2, the same applies to the anode 12 and the second current collector 16 of the first cell 10 mutatis mutandis, and to the anode 42 and the second current collector 46 of the fourth cell mutatis mutandis, if further electrochemical cells are comprised in the battery stack 200.

The composite cathode 11, 21, 31, 41 of each cell 10, 20, 30, 40 comprises the composite cathode material 1 depicted in FIG. 1. Taken together, the composite cathodes 11, 21, the gel polymer electrolyte layers 14, 24 and first current collector 15, 25, form an electrode 110. In the same way, taken together, the composite cathodes 31, 41, the gel polymer electrolyte layers 34, 44 and the first current collector 35, 45 form an electrode 120.

The anodes 12, 22, 32, 42 comprise material typically employed in conventional Li-ion electrochemical cells. Taken together, the anodes 22, 32, the ceramic layers 23, 33 and the second current collector 26, 36 of the second and third cells 20, 30 form an electrode 130.

FIG. 4 depicts a particular example of the electrode 130 shown in FIG. 3. The second current collector 26, 36 comprises a polymer substrate 50 and a layer of copper metal 52, 54 provided on each opposing face of the polymer substrate 50. Each layer of copper metal 52, 54 typically has a thickness of approximately 2 μm, and the polymer substrate 50 has a thickness of approximately 2 μm. A layer of lithium metal is provided as an anode layer 22, 32 on each opposing face of the current collector 26, 36. Each lithium anode layer 22, 32 has a thickness of approximately 1 μm. A ceramic layer 23, 33 comprising LiPON is encapsulates each lithium metal anode 22, 32. Each layer of LiPON 23, 33 has a thickness of approximately 1 μm. This method provides a double-sided protected lithium metal anode on a current collector with an overall thickness of approximately 10 μm.

FIG. 5 is a flow chart depicting a method 200 of manufacturing a composite cathode material according to examples.

The method 200 comprises mixing 210 particles of a cathode material with a gel polymer electrolyte precursor to provide a mixture. Mixing 210 the components of the mixture comprises any suitable process as described herein.

The method 200 further comprises crosslinking 220 the gel polymer electrolyte precursor of the mixture to provide the composite cathode material. Crosslinking 220 the gel polymer electrolyte comprises any suitable process as described herein.

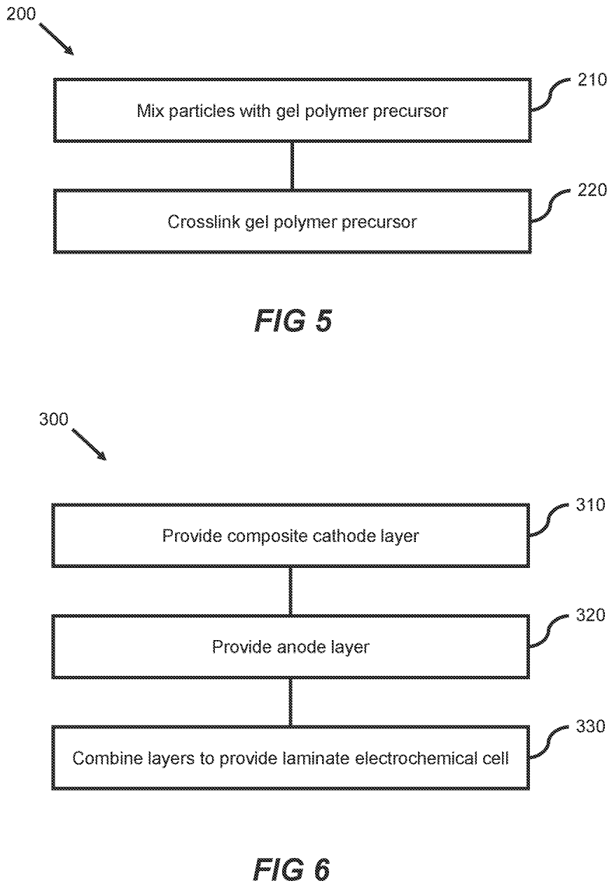

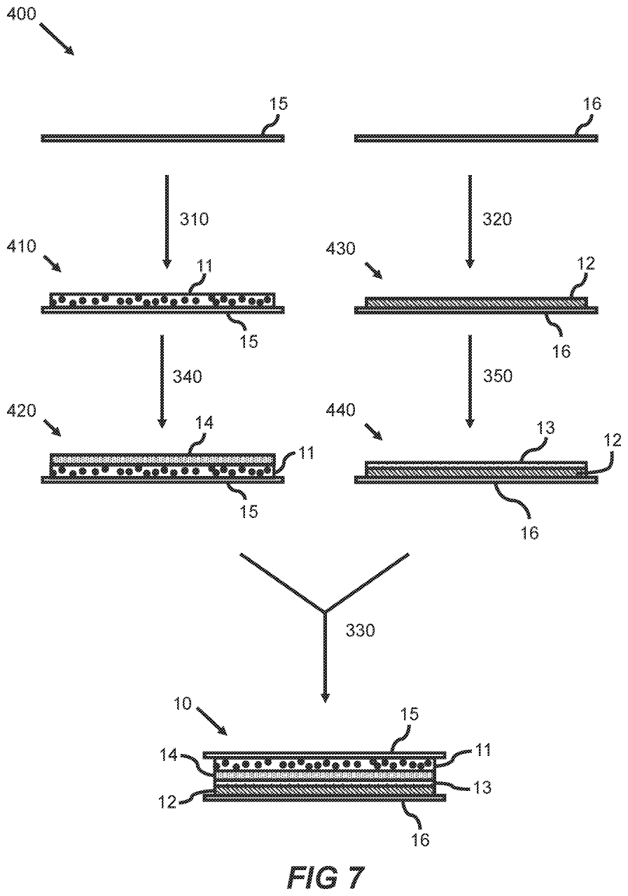

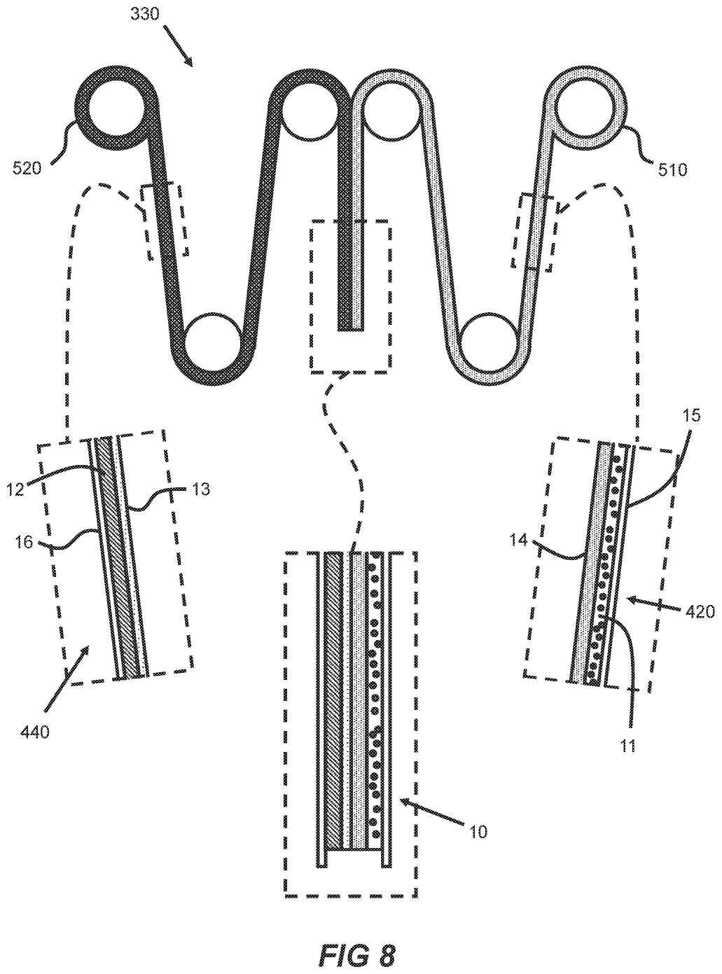

FIG. 6 is a flow chart depicting a method 300 of manufacturing an electrochemical cell according to examples. The method 300 comprises providing 310 a layer of composite cathode material comprising a gel polymer electrolyte and particles of a cathode material, the particles of the cathode material being arranged in the gel polymer electrolyte. Providing 310 the composite cathode layer comprises any suitable process as described herein.

The method 300 comprises providing 320 an anode layer. Providing 320 the anode layer comprises any suitable process described herein.

The method 300 comprises combining 330 the composite cathode layer and the anode layer provide the laminate battery cell. In examples (not shown), these items are combined such that further layers such as a gel polymer electrolyte layer and/or a ceramic layer are arranged between the composite cathode layer and the anode layer. The combining 330 comprises any suitable process described herein.

In examples (not shown in FIG. 6, but shown in FIG. 7), before the combining 330, the method 300 comprises providing 340 a gel polymer electrolyte layer on a surface of the composite cathode layer. The providing 340 a gel polymer electrolyte layer comprises any suitable process described herein.

In examples (not shown in FIG. 6, but shown in FIG. 7), before the combining 330, the method 300 comprises providing 350 a ceramic layer on a surface of the anode layer. The providing 350 a ceramic layer comprises any suitable process described herein.

FIG. 7 is a flow diagram illustrating schematically a method 400 according to an example of the method 300 depicted in FIG. 6 (a first example, and a second example). FIG. 7 shows cross-sections of an electrochemical cell 10 and component portions of the electrochemical cell 10 at points in the method 400. Where aspects of FIG. 7 correspond to features or method blocks depicted in previously-described figures, the same reference numbers are employed to aid understanding only. For the avoidance of doubt, limitations or requirements described in respect of the previously-described figures do not apply to the method 400 depicted in FIG. 7, and vice versa.

The method 400 comprises providing 310 a composite cathode layer 11. The composite cathode layer 11 is provided on a current collector 15 as a current collector-composite cathode laminate 410 (a composite cathode laminate). The composite cathode layer 11 is provided 310 by mixing particles of a cathode material with a gel polymer electrolyte precursor, supplying the mixture to a surface of the current collector 15, and cross-linking the gel polymer electrolyte precursor of the mixture to provide the composite cathode layer 11 on the current collector 15.

The method 400 further comprises providing 340 a gel polymer electrolyte layer 14 on the composite cathode layer 11. The gel polymer electrolyte layer 14 is provided by casting a mixture of lithium salt, polymer, and solvent onto a surface of the cathode layer 11 and crosslinking the mixture to provide the gel polymer electrolyte layer 14. Together, the current collector 15, cathode 11 and gel polymer electrolyte layer 14 form a composite cathode-electrolyte laminate 420.

The method 400 further comprises providing 320 an anode layer 12. Providing 320 the anode layer 12 comprises depositing lithium metal on a current collector 16 to provide a lithium metal film via thermal deposition. The anode layer 12 and current collector 16 together form an anode laminate 430.

The method 400 further comprises providing 350 a ceramic layer 13. Providing 350 the ceramic layer 13 comprises depositing ceramic material via vacuum deposition such as PVD or CVD. Together, the current collector 16, anode 12 and ceramic layer 13 form an anode-ceramic laminate 440.

The method 400 comprises combining 340 the layers to form an electrochemical cell 10. In the example depicted, the combining 340 comprises aligning the anode-ceramic laminate 440 with the composite cathode-electrolyte laminate 420, and hot rolling or pressing the laminates 340 to provide the cell 10.

FIG. 7 depicts an example of the combining 340 step of the method 400 shown in FIG. 7. In this example, the combining 340 is a roll-to-roll manufacturing method. The cathode-electrolyte laminate 420 has been wound into a first bobbin or roll 510, and the anode-ceramic laminate 440 has been wound into a second bobbin or roll 520. The first 510 and second 520 rolls are fed into a roller apparatus and pressed together to provide the cell 10.

The above examples are illustrative. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A composite cathode material comprising a gel polymer electrolyte and particles of a cathode material, the particles of the cathode material being arranged in the gel polymer electrolyte.

2. The composite cathode material according to claim 1, wherein the particles of the cathode material are comprised in the composite cathode material in an amount of at least 50 wt % of the composite cathode material, on a dry weight basis.

3. The composite cathode material according to claim 1, wherein the particles of the cathode material are arranged in the gel polymer electrolyte such that they are substantially homogenously dispersed throughout the gel polymer electrolyte.

4. The composite cathode material according to claim 1, wherein the gel polymer electrolyte is obtainable from a UV-crosslinkable gel polymer electrolyte precursor.

5. The composite cathode material according to claim 1, wherein the gel polymer electrolyte comprises polyethylene oxide (PEO), polypropylene oxide (PPO), polymethylmethacrylate (PMMA) polyacrylonitrile (PAN), polyvinylidene difluoride (PVDF), a combination thereof, or one or more copolymers obtainable therefrom.

6. The composite cathode material according to claim 1, wherein the gel polymer electrolyte comprises LiClO₄, LiBF₄, LIPF₆, LiAsF₆, LiCF₃SO₃, LiN(CF₃SO₂)₂ (LiTFSI), or a combination thereof.

7. The composite cathode material according to claim 1, wherein the gel polymer electrolyte comprises polyethylene glycol (PEG), polyethylene glycol dimethyl ether (PEGDME), dibutyl phthalate (DBP), dimethyl phthalate (DMP), dioctyl phthalate (DOP), succinonitrile (SN), ethylene carbonate (EC), propylene carbonate (PC), diethyl carbonate (DEC), dimethyl carbonate (DMC), γ-butyrolactone (γ-BL), or a combination thereof.

8. The composite cathode material according to claim 1, wherein the particles of the cathode material comprise lithium cobalt oxide (LiCoO₂), lithium manganese oxide (LiMn₂O₄), lithium nickel manganese cobalt oxide (LiNiMnCoO₂), lithium iron phosphate (LiFePO₄), lithium nickel cobalt aluminium oxide (LiNiCoAlO₂), lithium titanate (Li₂TiO₃), or a combination thereof.

9. The composite cathode material according to claim 1, wherein the particles of the cathode material have an average particle size of less than 0.1 μm.

10. The composite cathode material according to claim 1, wherein the composite cathode material is porous.

11. A method of manufacturing a composite cathode material comprising:
mixing particles of a cathode material with a gel polymer electrolyte precursor to provide a mixture; and
cross-linking the gel polymer electrolyte precursor of the mixture to provide the composite cathode material.

12. The method according to claim 11, wherein the mixture is cast to form a sheet of mixture before cross-linking the gel polymer electrolyte precursor.

13. The method according to claim 11, wherein the mixture is supplied to a mold before cross-linking the gel polymer electrolyte precursor.

14. The method according to claim 11, wherein the mixture is supplied to a surface of a current collector before cross-linking the gel polymer electrolyte precursor.

15. The method according to claim 11, wherein the cross-linking comprises supplying the gel polymer electrolyte precursor with UV radiation.

16. The method according to claim 11, wherein after the cross-linking, the composite cathode material is wound into a bobbin.

17. A laminate electrochemical cell comprising:
an anode layer; and
a composite cathode layer comprising the composite cathode material of claim 1.

18. The laminate electrochemical cell according to claim 17, further comprising a gel polymer electrolyte layer arranged between the anode layer and the composite cathode layer.

19. The laminate electrochemical cell according to claim 17, further comprising a ceramic layer arranged between the anode layer and the composite cathode layer.

20. The laminate electrochemical cell according to claim 19, wherein the ceramic layer comprises lithium phosphorous oxy-nitride (LiPON).

21. The laminate electrochemical cell according to claim 17, wherein the anode layer comprises silicon, carbon (optionally as graphite, graphene, activated carbon and/or carbon black), indium tin oxide (ITO), molybdenum dioxide (MoO₂), lithium titanate (Li₂TiO₃), lithium alloy, metallic lithium, copper, or combinations thereof.

22. A method of manufacturing a laminate electrochemical cell, the method comprising:
providing a layer of composite cathode material comprising a gel polymer electrolyte and particles of a cathode material, the particles of the cathode material being arranged in the gel polymer electrolyte;
providing an anode layer; and
combining the layer of composite cathode material and the anode layer to provide the laminate electrochemical cell.

23. The method according to claim 22, wherein the providing the layer of composite cathode material comprises:
supplying a mixture of gel polymer electrolyte precursor and particles of a cathode material to a surface of a first current collector; and
cross-linking the gel polymer electrolyte precursor of the mixture to provide the layer of composite cathode material.

24. The method according to claim 22, further comprising providing a gel polymer electrolyte layer on a surface of the layer of composite cathode material, wherein the combining the layer of composite cathode material and the anode layer comprises arranging the gel polymer electrolyte layer between the layer of composite cathode material and the anode layer.

25. The method according to claim 22, further comprising providing a ceramic layer on a surface of the anode layer, wherein the combining the layer of composite cathode material and the anode layer comprises arranging the ceramic layer between the layer of composite cathode material and the anode layer.

26. A battery stack comprising a plurality of laminate electrochemical cells, each cell comprising:
a first current collector;
a composite cathode layer arranged on a surface of the first current collector, the composite cathode layer comprising a gel polymer electrolyte and particles of a cathode material, the particles of the cathode material being arranged in the gel polymer electrolyte;
a second current collector; and
an anode layer arranged on a surface of the second current collector.

27. The battery stack according to claim 26, wherein the plurality of electrochemical cells comprises a first electrochemical cell and a second electrochemical cell, configured such that the first current collector of the first cell is also the first current collector of the second cell.

28. An electrically-powered device comprising the laminate electrochemical cell according to claim 17.
